(19) United States
(12) Patent Application Publication
(10) Pub. No.: US 2010/0012408 A1
(43) Pub. Date: Jan. 21, 2010

(54) DRIVE CONTROL APPARATUS FOR ROTATING ELECTRIC MACHINE AND VEHICLE

(75) Inventor: Akira Takasaki, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/449,589

(22) PCT Filed: Feb. 20, 2008
(86) PCT No.: PCT/JP2008/053351

§ 371 Date: Aug. 14, 2009

(30) Foreign Application Priority Data
Feb. 21, 2007 (JP) 2007-040838

(51) Int. Cl. B60K 6/48; H02P 6/10

(52) U.S. Cl. 180/65.25; 318/400.09

(57) ABSTRACT

A drive control apparatus for an AC motor is mounted on a hybrid vehicle. The drive control apparatus includes an inverter for driving an AC motor, and a control device for controlling the inverter by switching a control mode of the inverter between a first mode and a second mode in which a harmonic component of output current of the inverter can be suppressed as compared with in the first mode. The control device controls the inverter in the first mode when a magnet temperature of a permanent magnet is smaller than a first threshold temperature, and controls the inverter in the second mode when a magnet temperature is equal to or larger than the first threshold temperature.

### TECHNICAL FIELD

The present invention relates to a drive control apparatus for a rotating electric machine and a vehicle, and more particularly to a technique of preventing demagnetization of a permanent magnet included in a rotor in a permanent magnetic synchronous machine.

### BACKGROUND ART

In recent years, electric powered vehicles such as hybrid vehicles and electric vehicles receive great attention as environmentally friendly cars. Such an electric powered vehicle includes a power storage device such as a secondary battery and a motor generator receiving electric power from the power storage device for generating a driving force. The motor generator generates a driving force at a time of starting or acceleration and also converts kinetic energy of the vehicle into electric energy for recovery into the power storage device at a time of braking.

As a motor generator mounted on such an electric powered vehicle, a permanent magnetic synchronous machine is often used, because of easiness of increasing magnetic flux density and power regeneration. Specifically, an interior permanent magnet synchronous machine is frequently employed in which driving torque (reluctance torque) generated by asymmetry of magnetic reluctance can be used in combination.

Permanent magnets are generally known to have magnetic coercive force changed according to environmental temperatures. For example, when a ferromagnetic material that is a main component of a permanent magnet is exposed in a high environmental temperature exceeding a Curie temperature marking a phase transition, the magnetic coercive force of the permanent magnet decreases, possibly causing irreversible demagnetization.

Japanese Patent Laying-Open No. 2001-157304 discloses a rotating electric machine for a hybrid car in which demagnetization of a magnet due to a temperature increase can be prevented. The hybrid car includes first and second rotating electric machines and a control device. The control device estimates a temperature of a permanent magnet of the first rotating electric machine based on data input for control of an engine and the first and second rotating electric machines. The control device estimates a temperature of an armature coil from the temperature of the permanent magnet to set the maximum carrying current value based on the armature coil temperature. The control device limits the current value in the armature to the maximum value or lower.

The output of the rotating electric machine may abruptly change when current flowing in the rotating electric machine is limited in order to prevent demagnetization of the magnet. When the output of the rotating electric machine mounted on the vehicle abruptly changes, a sudden change may occur in driving of the vehicle. Japanese Patent Laying-Open No. 2001-157304, however, does not mention such a problem.

### DISCLOSURE OF THE INVENTION

An object of the present invention is to provide a drive control apparatus for a rotating electric machine for allowing a permanent magnet included in the rotating electric machine to be prevented from demagnetization, and a vehicle including the drive control apparatus.

In summary, the present invention provides a drive control apparatus for a first rotating electric machine including a first rotor including a first permanent magnet. The drive control apparatus includes a temperature estimation unit, a first inverter, and a control unit. The temperature estimation unit estimates a temperature of the first permanent magnet based on a first operating condition requested of the first rotating electric machine and outputs a magnet temperatures as the estimation result. The first inverter drives the first rotating electric machine to rotate the first rotor. The control unit has, as control modes of the first inverter, a first mode and a second mode in which a harmonic component of output current from the first inverter to the first rotating electric machine can be suppressed as compared with in the first mode. The control unit controls the first inverter in the first mode when the magnet temperature is smaller than a first threshold temperature, and controls the first inverter in the second mode when the magnet temperature is larger than the first threshold temperature.

Preferably, the control unit limits the output current of the first inverter in a case where the magnet temperature exceeds a second threshold temperature, when the first inverter is controlled in the second mode.

Preferably, the first mode is a pulse width modulation control mode. The second mode is a rectangular wave control mode.

Preferably, when the control mode is the second mode, the control unit controls the first inverter such that a revolution number of the first rotating electric machine is reduced as compared with when the control mode is the first mode.

More preferably, the first rotating electric machine is mounted on a vehicle. The vehicle includes a drive wheel, a second rotating electric machine for rotating the drive wheel, an internal combustion engine, and a power split device. The power split device is configured to have the second rotating electric machine and the drive wheel coupled thereto and have the internal combustion engine and the first rotating electric machine coupled thereto so that a revolution number of the second rotating electric machine is uniquely defined from a revolution number of the first rotating electric machine and a revolution number of the internal combustion engine. When the revolution number of the first rotating electric machine is decreased, the internal combustion engine increases the revolution number of the internal combustion engine so that the revolution number of the second rotating electric machine is kept constant.

Further preferably, the second rotating electric machine includes a second rotor including a second permanent magnet. The temperature estimation unit estimates a temperature of the second permanent magnet based on a second operating condition requested of the second rotating electric machine. The drive control apparatus further includes a second inverter for driving the second rotating electric machine to rotate the second rotor. When the temperature of the second permanent magnet as estimated by the temperature estimation unit exceeds a prescribed temperature, the control unit limits output current from the second inverter to the second rotating electric machine.

Preferably, when the control mode is the second mode, the control unit increases a carrier frequency of the first inverter as compared with when the control mode is the first mode.

In accordance with another aspect of the present invention, a vehicle includes a first rotating electric machine including a first rotor having a first permanent magnet and a drive control apparatus for driving and controlling the first rotating electric machine. The drive control apparatus includes a temperature estimation unit, a first inverter, and a control unit. The temperature estimation unit estimates a temperature of the first permanent magnet based on a first operating condition requested of the first rotating electric machine and outputs a magnet temperature as the estimation result. The first inverter drives the first rotating electric machine to rotate the first rotor. The control unit has, as control modes of the first inverter, a first mode and a second mode in which a harmonic component of output current from the first inverter to the first rotating electric machine can be suppressed as compared with in the first mode. The control unit controls the first inverter in the first mode when the magnet temperature is smaller than a first threshold temperature, and controls the first inverter in the second mode when the magnet temperature is larger than the first threshold temperature.

Preferably, the output current of the first inverter is limited when the magnet temperature exceeds a second threshold temperature, when the first inverter is controlled in the second mode.

Preferably, the first mode is a pulse width modulation control mode. The second mode is a rectangular wave control mode.

Preferably, when the control mode is the second mode, the control unit controls the first inverter such that a revolution number of the first rotating electric machine is reduced as compared with when the control mode is the first mode.

More preferably, the vehicle further includes a drive wheel, a second rotating electric machine for rotating the drive wheel, an internal combustion engine, and a power split device. The power split device is configured to have the second rotating electric machine and the drive wheel coupled thereto and have the internal combustion engine and the first rotating electric machine coupled thereto so that a revolution number of the second rotating electric machine is uniquely defined from a revolution number of the first rotating electric machine and a revolution number of the internal combustion engine. When the revolution number of the first rotating electric machine is decreased, the internal combustion engine increases the revolution number of the internal combustion engine so that the revolution number of the second rotating electric machine is kept constant.

Further preferably, the second rotating electric machine includes a second rotor having a second permanent magnet. The temperature estimation unit estimates a temperature of the second permanent magnet based on a second operating condition requested of the second rotating electric machine. The drive control apparatus further includes a second inverter for driving the second rotating electric machine to rotate the second rotor. When the temperature of the second permanent magnet as estimated by the temperature estimation unit exceeds a prescribed temperature, the control unit limits output current from the second inverter to the second rotating electric machine.

Preferably, when the control mode is the second mode, the control unit increases a carrier frequency of the first inverter as compared with when the control mode is the first mode.

In accordance with the present invention, it is possible to suppress a temperature increase of a permanent magnet included in a rotating electric machine by suppressing a harmonic component of output current of an inverter, thereby preventing demagnetization of the permanent magnet.

### BRIEF DESCRIPTION OF THE DRAWINGS

FIG. 1 is a schematic block diagram showing an exemplary hybrid vehicle equipped with a drive control apparatus for a rotating electric machine in accordance with an embodiment of the present invention.

FIG. 2 is a schematic diagram of a power split device 210 shown in FIG. 1.

FIG. 3 is a diagram showing in detail a part concerning drive control of AC motors M1, M2 in a hybrid vehicle drive apparatus 100 in FIG. 1.

FIG. 4 is a diagram illustrating a configuration of inverters 14, 31.

FIG. 5 shows an exemplary configuration of a main part of a permanent magnet rotating electric machine for use in AC motors M1, M2.

FIG. 6 is a functional block diagram of a control device 30 in FIG. 1.

FIG. 7 is a diagram illustrating eddy current produced in a permanent magnet.

FIG. 8 is a waveform diagram for illustrating a method of generating signals DRV1, DRV2 by an inverter control unit 303 shown in FIG. 6

FIG. 9 is a graph showing the relation between a carrier frequency and output current of the inverter

FIG. 10 is a diagram showing a map stored by a temperature estimation unit 302 in FIG. 6.

FIG. 11 is a flowchart illustrating a temperature estimation process executed by temperature estimation unit 302 in FIG. 6.

FIG. 12 is a flowchart illustrating a control process for AC motor M1 in the present embodiment.

FIG. 13 is a graph illustrating a movement of an operating point of AC motor M1 in a revolution number control process.

FIG. 14 is a graph illustrating the relation between a magnet temperature Tmg and a revolution number of AC motor M1.

FIG. 15 is a nomographic chart for illustrating an operation of power split device 210 shown in FIG. 2.

FIG. 16 is a graph illustrating a movement of an operating point of AC motor M1 in a load factor limiting process.

FIG. 17 is a graph illustrating the relation between magnet temperature Tmg and a load factor of AC motor M1.

FIG. 18 is a nomographic chart for illustrating an operation of power split device 210 in the load factor limiting process.

FIG. 19 is a flowchart illustrating a control process for AC motor M2 in the present embodiment.

FIG. 20 is a flowchart showing another example of a control process for AC motors M1, M2.

FIG. 21 is a flowchart showing yet another example of a control process for AC motors M1, M2.

### BEST MODES FOR CARRYING OUT THE INVENTION

In the following, an embodiment of the present invention will be described in detail with reference to the drawings. It is noted that the same or corresponding parts in the figures are denoted with the same reference characters and the description will not be repeated.

[Overall Configuration]

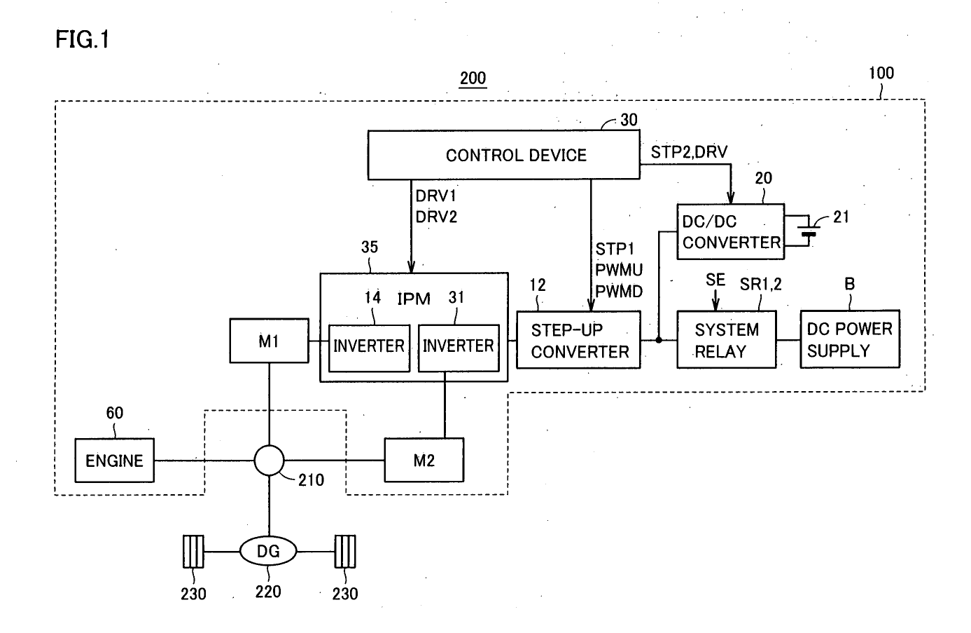

FIG. 1 is a schematic block diagram showing an exemplary hybrid vehicle equipped with a drive control apparatus for a rotating electric machine in accordance with an embodiment of the present invention.

Referring to FIG. 1, a hybrid vehicle 200 includes a hybrid vehicle drive apparatus 100, a power split device 210, a differential gear (DG) 220, and front wheels 230. Hybrid vehicle drive apparatus 100 includes a DC power supply B, system relays SR1, SR2, a step-up converter 12, inverters 14, 31, a DC/DC converter 20, an auxiliary battery 21, a control device 30, an engine 60, and AC motors M1, M2. Inverters 14, 31 constitute an IPM (intelligent power module) 35.

AC motor M1 is coupled to engine 60 through power split device 210. Then, AC motor M1 starts engine 60 or generates electric power using a rotational force of engine 60. On the other hand, AC motor M2 drives front wheels 230 through power split device 210.

AC motors M1, M2 are permanent magnetic, three-phase AC synchronous rotating electric machines, by way of example. In other words, each of AC motors M1, M2 is formed to rotate a rotor having a permanent magnet by current magnetic field (rotating magnetic field) produced by drive current flowing in a coil provided for a stator.

DC power supply B is formed of a secondary battery such as a nickel metal hydride or lithium ion battery. System relays SR1, SR2 are turned on/off in response to a signal SE from control device 30. More specifically, system relays SR1, SR2 are turned on in response to signal SE of H (logic high) level from control device 30 and turned off in response to signal SE of L (logic low) level from control device 30.

Step-up converter 12 steps up DC voltage supplied from DC power supply B and supplies the voltage to inverters 14, 31. More specifically, step-up converter 12 receives a signal PWMU from control device 30 to step up and then supply DC voltage to inverters 14, 31. Step-up converter 12 also receives a signal PWMD from control device 30 to step down and then supply DC voltage supplied from inverter 14 (or 31) to DC power supply B and DC/DC converter 20. In addition, step-up converter 12 stops the step-up operation and the step-down operation in response to a signal STP1 from control device 30.

Inverter 14 receives DC voltage supplied from step-up converter 12 and then converts the DC voltage into AC voltage for driving AC motor M1, based on a signal DRV1 from control device 30. Inverter 14 also converts the AC voltage generated by AC motor M1 into DC voltage based on signal DRV1 from control device 30 and supplies the converted DC voltage to step-up converter 12.

Inverter 31 receives DC voltage supplied from step-up converter 12 and then converts the DC voltage into AC voltage for driving AC motor M2, based on a signal DRV2 from control device 30. At a time of regenerative braking of the hybrid vehicle equipped with hybrid vehicle drive apparatus 100, inverter 31 converts the AC voltage generated by AC motor M2 into DC voltage based on signal DRV2 from control device 30 and supplies the converted DC voltage to step-up converter 12.

It is noted that regenerative braking referred to herein includes braking involving regeneration in a case where a foot brake operation is performed by a driver who drives the hybrid vehicle, and deceleration (or stopping acceleration) of the vehicle with regeneration caused by lifting off the accelerator pedal during travel although the foot brake is not operated.

DC/DC converter 20 is driven by signal DRV from control device 30 and converts DC voltage from DC power supply B for charging auxiliary battery 21. DC/DC converter 20 is stopped in response to a signal STP2 from control device 30. Auxiliary battery 21 stores electric power supplied from DC/DC converter 20.

Control device 30 generates signal DRV1 for controlling inverter 14 when inverter 14 drives AC motor M1, and outputs the generated signal DRV1 to inverter 14. Control device 30 also generates signal DRV2 for controlling inverter 31 when inverter 31 drives AC motor M2, and outputs the generated signal DRV2 to inverter 31.

Furthermore, when inverter 14 (or 31) drives AC motor M1 (or M2), control device 30 generates signal PWMU for controlling step-up converter 12 and outputs the generated signal PWMU to step-up converter 12.

In addition, at a time of regenerative braking of hybrid vehicle 200 equipped with hybrid vehicle drive apparatus 100, control device 30 generates signals DRV1, DRV2 for converting the AC voltage generated in AC motor M1 or M2 into DC voltage and outputs signals DRV1, DRV2 to inverter 14, 31, respectively.

In addition, at a time of regenerative braking of hybrid vehicle 200, control device 30 generates signal PWMD for stepping down the DC voltage supplied from inverter 14 (or 31) and outputs the generated signal PWMD to step-up converter 12.

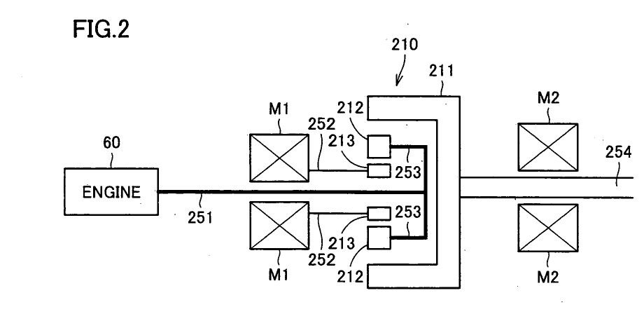

FIG. 2 is a schematic diagram of power split device 210 shown in FIG. 1. Referring to FIG. 2, power split device 210 includes a ring gear 211, a carrier gear 212, and a sun gear 213. A shaft 251 of engine 60 is connected to carrier gear 212 through a planetary carrier 253, a shaft 252 of AC motor M1 is connected to sun gear 213, and a shaft 254 of AC motor M2 is connected to ring gear 211. Shaft 254 of AC motor M2 is coupled to a drive shaft of front wheel 230 through DG 220.

AC motor M1 rotates shaft 251 through shaft 252, sun gear 213, carrier gear 212, and planetary carrier 253 to start engine 60. AC motor M1 also receives a rotational force of engine 60 through shaft 251, planetary carrier 253, carrier gear 212, sun gear 213, and shaft 252 and generates electric power using the received rotational force.

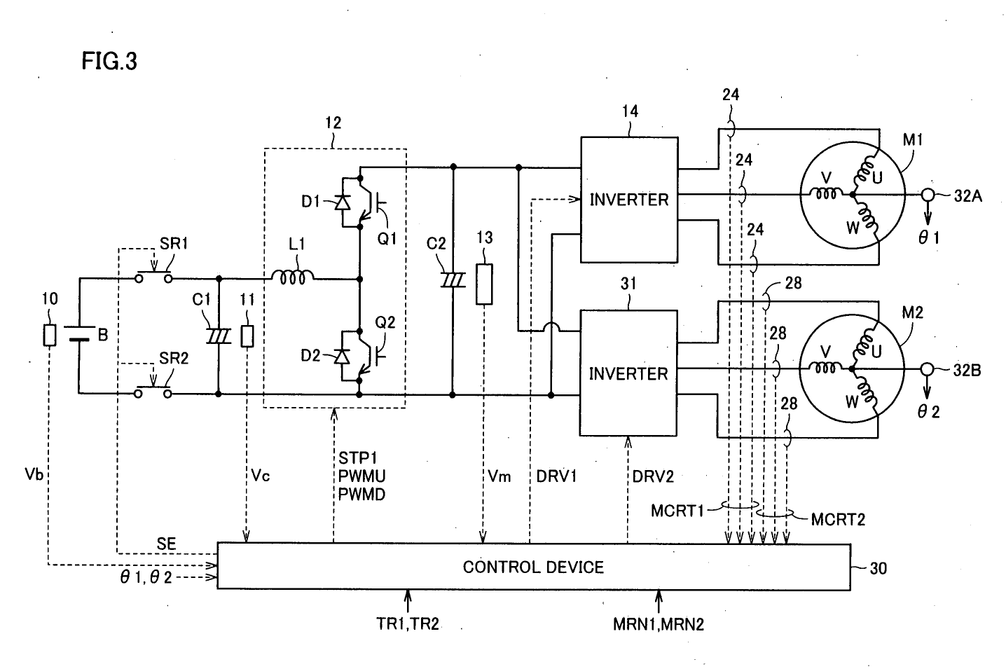

FIG. 3 is a diagram showing in detail a part concerning drive control of AC motors M1, M2 in hybrid vehicle drive apparatus 100 in FIG. 1.

Referring to FIG. 3, DC power supply B outputs DC voltage. A voltage sensor 10 detects a voltage Vb output from DC power supply B and outputs the detected voltage Vb to control device 30.

System relays SR1, SR2 are turned on in response to signal SE from control device 30 and then supplies DC voltage from DC power supply B to a capacitor C1. Capacitor C1 smoothes the DC voltage supplied from DC power supply B through system relays SR1, SR2 and supplies the smoothed DC voltage to step-up converter 12. A voltage sensor 11 detects a voltage Vc across the ends of capacitor C1 and outputs the detected voltage Vc to control device 30.

Step-up converter 12 includes a reactor L1, IGBT (Insulated Gate Bipolar Transistor) elements Q1, Q2, and diodes D1, D2. Reactor L1 has one end connected to a power supply line of DC power supply B and the other end connected to a midpoint between IGBT element Q1 and IGBT element Q2, that is, between the emitter of IGBT element Q1 and the collector of IGBT element Q2. IGBT elements Q1, Q2 are connected in series between the power supply line and a ground line. Then, the collector of IGBT element Q1 is connected to the power supply line, and the emitter of IGBT element Q2 is connected to the ground line. Diodes D1, D2 each supplying current from the emitter side to the collector side are arranged between the respective collectors and emitters of IGBT elements Q1, Q2, respectively.

Step-up converter 12 has IGBT elements Q1, Q2 turned on/off by control device 30 and steps up the DC voltage supplied from capacitor C1 to supply the output voltage to a capacitor C2. Furthermore, step-up converter 12 steps down the DC voltage generated by AC motor M1 or M2 and converted by inverter 14 or 31 at a time of regenerative braking of the hybrid vehicle and supplies the voltage to capacitor C1.

Capacitor C2 smoothes the DC voltage supplied from step-up converter 12 and supplies the smoothed DC voltage to inverters 14, 31. A voltage sensor 13 detects a voltage across the opposite sides of capacitor C2, that is, an output voltage Vm of step-up converter 12.

Inverter 14 receives DC voltage supplied from capacitor C2 and then converts the DC voltage into AC voltage for driving AC motor M1, based on signal DRV1 from control device 30. Accordingly, AC motor M1 is driven to generate torque specified by a torque command value TR1. At a time of regenerative braking of the hybrid vehicle equipped with hybrid vehicle drive apparatus 100, inverter 14 converts the AC voltage generated by AC motor M1 into DC voltage based on signal DRV1 from control device 30 and supplies the converted DC voltage to step-up converter 12 through capacitor C2.

Inverter 31 receives DC voltage supplied from capacitor C2 and then converts the DC voltage into AC voltage for driving AC motor M2, based on signal DRV2 from control device 30. Accordingly, AC motor M2 is driven to generate torque specified by a torque command value TR2. At a time of regenerative braking of the hybrid vehicle equipped with hybrid vehicle drive apparatus 100, inverter 31 converts the AC voltage generated by AC motor M2 into DC voltage based on signal DRV2 from control device 30 and supplies the converted DC voltage to step-up converter 12 through capacitor C2.

A rotation angle detection unit 32A is arranged for AC motor M1. Rotation angle detection unit 32A is coupled to the rotation shaft of AC motor M1. Rotation angle detection unit 32A detects a rotation angle θ1 based on a rotational position of the rotor of AC motor M1 and outputs the detected rotation angle θ1 to control device 30.

A rotation angle detection unit 32B is arranged for AC motor M2. Rotation angle detection unit 32B is coupled to the rotation shaft of AC motor M2. Rotation angle detection unit 32B detects a rotation angle θ2 based on a rotational position of the rotor of AC motor M2 and outputs the detected rotation angle θ2 to control device 30.

Control device 30 receives torque command values TR1, TR2 and motor revolution numbers MRN1, MRN2 from an ECU (Electrical Control Unit) provided on the outside. Control device 30 further receives voltage Vb from voltage sensor 10, receives voltage Vc from voltage sensor 11, receives voltage Vm from voltage sensor 13, receives motor current MCRT1 from a current sensor 24, and receives motor current MCRT2 from a current sensor 28. Control device 30 further receives rotation angles θ1, θ2 from rotation angle detection units 32A, 32B, respectively.

Control device 30 generates signal DRV1 for controlling switching of the switching elements included in inverter 14, based on voltage Vm, motor current MCRT1, torque command value TR1, and rotation angle θ1, when inverter 14 drives AC motor M1. Control device 30 outputs the generated signal DRV1 to inverter 14.

Control device 30 generates signal DRV2 for controlling switching of the switching elements included in inverter 31, based on voltage Vm, motor current MCRT2, torque command value TR2, and rotation angle θ2, when inverter 31 drives AC motor M2. Control device 30 outputs the generated signal DRV2 to inverter 31.

Control device 30 generates signal PWMU for controlling switching of IGBT elements Q1, Q2 of step-up converter 12, based on voltages Vb, Vm, torque command value TR1 (or TR2), and motor revolution number MRN1 (or MRN2) when inverter 14 (or 31) drives AC motor M1 (or M2). Control device 30 outputs the generated signal PWMU to step-up converter 12.

At a time of regenerative braking of hybrid vehicle 200, control device 30 generates signals DRV1, 2 for converting the AC voltage generated in AC motor M1 or M2 into DC voltage. Control device 30 outputs signal DRV1 to inverter 14 and outputs signal DRV2 to inverter 31. In this case, the switching of the switching elements of inverters 14, 31 is controlled by signals DRV1, 2. Accordingly, inverter 14 converts AC voltage generated in AC motor M1 into DC voltage, which is supplied to step-up converter 12, and inverter 31 converts AC voltage generated in AC motor M2 into DC voltage, which is supplied to step-up converter 12.

Control device 30 also generates signal PWMD for stepping down DC voltage supplied from inverter 14 (or 31) and outputs the generated signal PWMD to step-up converter 12. Accordingly, the AC voltage generated by AC motor M1 or M2 is converted into DC voltage and then stepped down to be supplied to DC power supply B.

FIG. 4 is a diagram illustrating a configuration of inverters 14, 31. The configuration of inverter 31 is similar to the configuration of inverter 14. Although the configuration of inverter 14 is representatively described below, the configuration of inverter 31 is equivalent to the one formed by replacing “inverter 14” with “inverter 31” in the configuration of inverter 14 described below.

Referring to FIG. 4, inverter 14 includes a U-phase arm 15, a V-phase arm 16, and a W-phase arm 17. U-phase arm 15, V-phase arm 16, and W-phase arm 17 are provided in parallel between a power supply line 1 and a ground line 2.

U-phase arm 15 is comprised of IGBT elements Q3, Q4 connected in series, V-phase arm 16 is comprised of IGBT elements Q5, Q6 connected in series, and W-phase arm 17 is comprised of IGBT elements Q7, Q8 connected in series. Furthermore, diodes D3-D8 each feeding current from the emitter side to the collector side are connected between the respective collectors and emitters of IGBT elements Q3-Q8, respectively.

The midpoint of each phase arm of inverter 14 is connected to each phase end of each phase coil of AC motor M1. In other words, the other end of the U-phase coil of AC motor M1 is connected to the midpoint between IGBT elements Q3 and Q4, the other end of the V-phase coil is connected to the midpoint between IGBT elements Q5 and Q6, and the other end of the W-phase coil is connected to the midpoint between IGBT elements Q7 and Q8. Similarly, the midpoint of each phase arm of inverter 31 is connected to each phase end of each phase coil of AC motor M2.

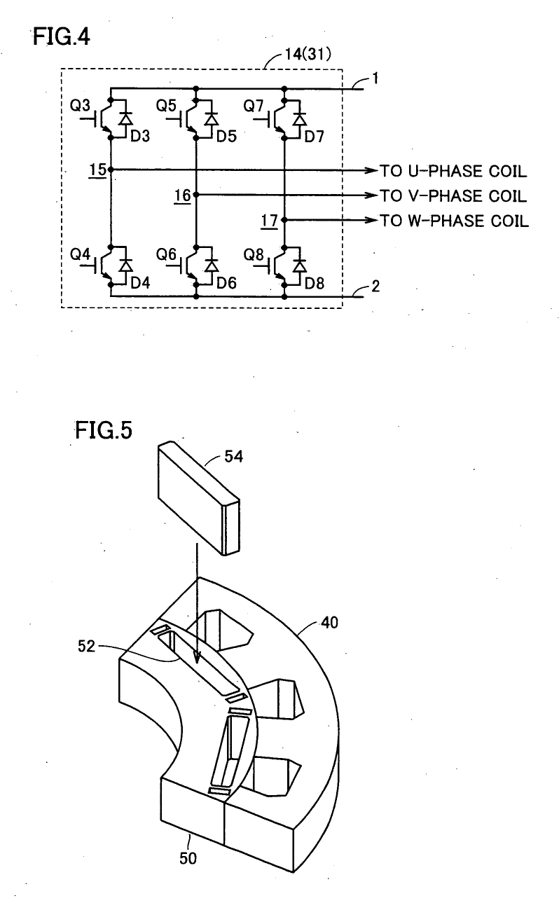

FIG. 5 shows an exemplary configuration of a main part of a permanent magnet rotating electric machine for use in AC motors M1, M2. Referring to FIG. 5, in the rotor of the permanent magnet synchronous machine, a pole is formed by forming a plurality of holes 52 in a rotor core 50 and inserting and arranging a permanent magnet 54 in each of holes 52. Then, in a stator 40, a plurality of coils (not shown) are arranged to surround rotor core 50. The rotor is rotatably driven based on a rotating magnetic field formed by supplying power to a plurality of coils.

Here, magnetic flux produced by the coils of stator 40 passes through permanent magnet 54, so that eddy current is generated in permanent magnet 54. The eddy current generated in the magnet causes such problems as heat generation and loss, which become conspicuous with size reduction, enhanced speed, and higher output of the rotating electric machine. Specifically, heat generation leads to demagnetization of the magnet and causes a failure of the rotating electric machine. Furthermore, the loss due to the eddy current reduces the efficiency of the rotating electric machine. Therefore, when the magnet temperature of the permanent magnet is equal to or lower than a prescribed threshold temperature, control device 30 controls inverters 14, 31 in a first mode, and when the magnet temperature exceeds the threshold temperature, control device 30 controls inverters 14, 31 in a second mode in which a temperature increase of the permanent magnet can be suppressed more than in the first mode.

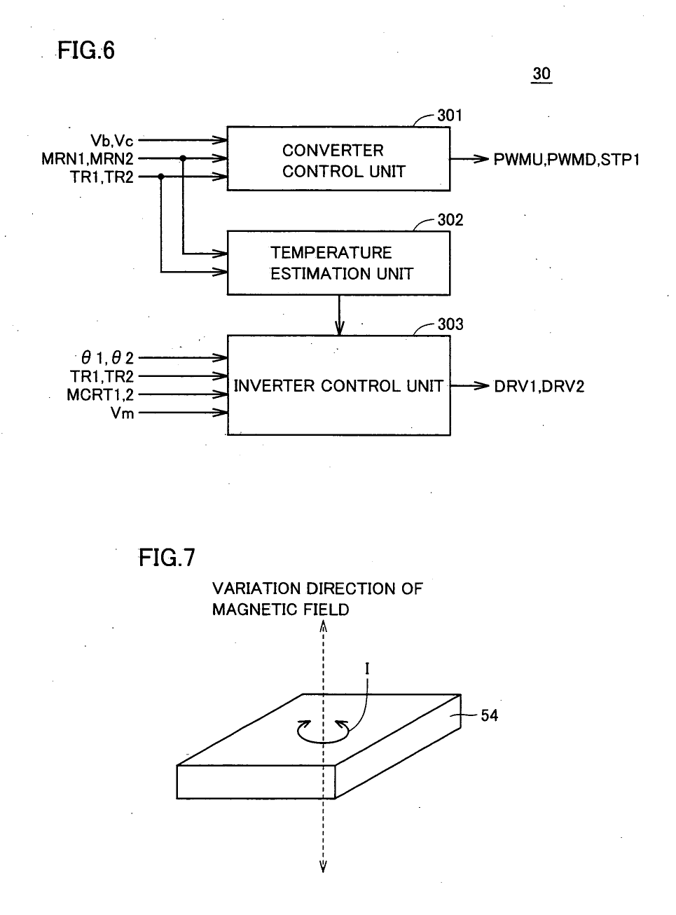

FIG. 6 is a functional block diagram of control device 30 in FIG. 1. It is noted that control device 30 shown in FIG. 6 may be realized by hardware or may be realized by software.

Referring to FIG. 6, control device 30 includes a converter control unit 301, a temperature estimation unit 302, and an inverter control unit 303. Converter control unit 301 generates and outputs signals PWMU, PWMD, STP1 based on voltage Vb of DC power supply B, voltage Vc of capacitor C1, motor revolution numbers MRN1, MRN2, and torque command values TR1, TR2.

Temperature estimation unit 302 estimates a temperature of the permanent magnet included in the rotor of AC motor M1 based on motor revolution number MRN1 and torque command value TR1. Temperature estimation unit 302 estimates a temperature of the permanent magnet included in the rotor of AC motor M2 based on motor revolution number MRN2 and torque command value TR2. The details of the temperature estimating method will be described later.

Inverter control unit 303 generates and outputs signals DRV1, DRV2 based on rotation angles θ1, θ2, torque command values TR1, TR2, motor current MCRT1, MCRT2, and output voltage Vm of step-up converter 12. Inverter control unit 303 receives the estimated value of the magnet temperature from temperature estimation unit 302. Inverter control unit 303 changes the control mode of AC motors M1, M2 from the first mode to the second mode when the magnet temperature exceeds a prescribed threshold temperature.

[Demagnetization Preventing Method]

FIG. 7 is a diagram illustrating eddy current generated in a permanent magnet. Referring to FIG. 7, when a magnetic field passing through permanent magnet 54 varies in the direction shown by the broken arrow, eddy current I is generated in permanent magnet 54. Eddy current I flows only in the vicinity of the surface of permanent magnet 54. Since Joule heat is generated by eddy current I, the temperature of permanent magnet 54 increases. As the magnetic field varies greater, eddy current I increases. As a result, the temperature of permanent magnet 54 becomes higher. It is noted that when the magnetic field passing through permanent magnet 54 is constant in terms of time, Joule heat is not generated by eddy current.

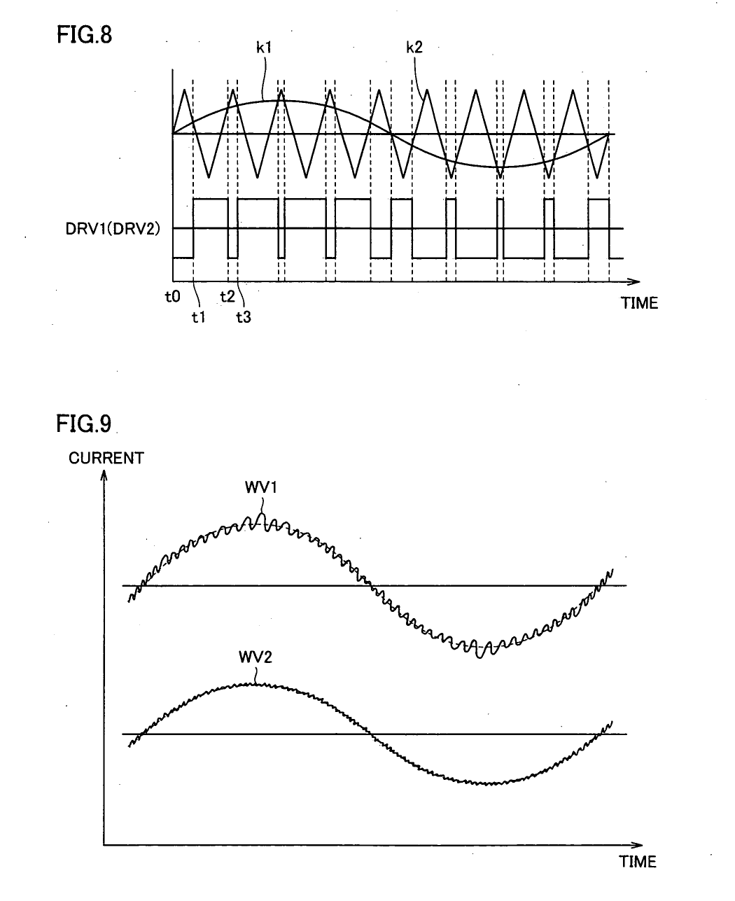

FIG. 8 is a waveform diagram for illustrating a method of generating signals DRV1, DRV2 by inverter control unit 303 shown in FIG. 6. It is noted that FIG. 8 representatively shows a method of generating signals DRV1, DRV2 corresponding to the U phase of AC motors M1, M2. However, the signal corresponding to each of the V and W phases of AC motors M1, M2 is also generated in a manner similar to the method of generating signals DRV1, DRV2 shown in FIG. 8.

Referring to FIG. 8 and FIG. 6, a curve k1 shows a U-phase voltage command signal calculated by inverter control unit 303. A triangular wave signal k2 is a carrier signal generated by inverter control unit 303.

Inverter control unit 303 compares curve k1 with triangular wave signal k2 and generates pulse-like signals DRV1, DRV2 each having a voltage value changing according to the magnitude relation between curve k1 and triangular wave signal k2. Inverter control unit 303 then outputs the generated signals DRV1, DRV2 to inverters 14, 31, respectively. IGBT elements Q3, Q4 included in U-phase arm 15 of each of inverters 14, 31 perform switching operations in accordance with the input signals.

IGBT elements Q3, Q4 perform switching operations at a switching frequency according to a carrier frequency of the carrier signal (triangular wave signal k2). The switching frequency of IGBT elements Q3, Q4 is changed by changing the carrier frequency of the carrier signal (triangular wave signal k2).

The switching frequency of the switching element of the inverter depends on a carrier frequency of a PWM signal. When the switching element of the inverter performs a switching operation, a harmonic component (ripple current) depending on that switching frequency is produced in the output current of the inverter. The order of the harmonic component is not specifically limited.

The greater the harmonic component is, the greater the magnetic field shown in FIG. 7 varies. Therefore, the eddy current generated in the permanent magnet becomes larger. As a result, the possibility that the magnet temperature rises up to the temperature at which demagnetization occurs is increased.

The magnitude of the harmonic component changes according to the number of peaks of the triangular wave included in one cycle of curve k1. In other words, as the carrier frequency changes, the harmonic component also changes.

FIG. 9 is a graph showing the relation between the carrier frequency and the output current of the inverter. It is noted that although FIG. 9 shows the output current of the U phase of the inverter, the output currents of the V phase and the W phase also change in a manner similar to the output current of the U phase.

Referring to FIG. 9, when the carrier frequency is low, the harmonic component (ripple current) included in the output current of the U phase becomes large as shown by a waveform WV1. By contrast, when the carrier frequency of triangular wave signal k2 is increased without changing the cycle of curve k1, the number of peaks of the triangular wave included in one cycle of curve k1 is increased. In this case, as shown by a waveform WV2, the harmonic component becomes small and the waveform of the output current becomes closer to a sinusoidal wave.

When the waveform of input current of the inverter is WV2, a magnet temperature increase can be suppressed as compared with when the waveform of input current of the inverter is WV1, so that it becomes possible to prevent demagnetization of the permanent magnet. It is noted that waveforms WV1, WV2 shown in FIG. 9 schematically show the actual waveforms for the sake of illustration.

Another method of preventing demagnetization of the permanent magnet includes reducing a magnetic field (demagnetizing field) in the direction opposite to that of the magnetic field of the permanent magnet as much as possible. As the demagnetizing field is larger, the temperature at which demagnetization occurs is lower.

The magnitude of the demagnetizing field is proportional to the current flowing in the coil of the stator. When the current flowing in the coil is limited in order to limit the load factor of the AC motor, the demagnetizing field is also reduced. Accordingly, it is possible to prevent the temperature at which demagnetization of the permanent magnet from being decreased. In other words, it becomes possible to prevent demagnetization of the permanent magnet.

[Magnet Temperature Estimation Method]

Since the rotor of the AC motor is rotatably configured, sensor wiring between the rotating rotor and the stationary stator side has to be formed of a rotation joint or the like in order to directly detect the temperature of the permanent magnet provided for the rotor using a temperature sensor or the like. This complicates the structure of the motor. Then, in the embodiment of the present invention, the control device estimates a magnet temperature of the permanent magnet based on the number of revolutions (revolution number) of the motor and a torque command value.

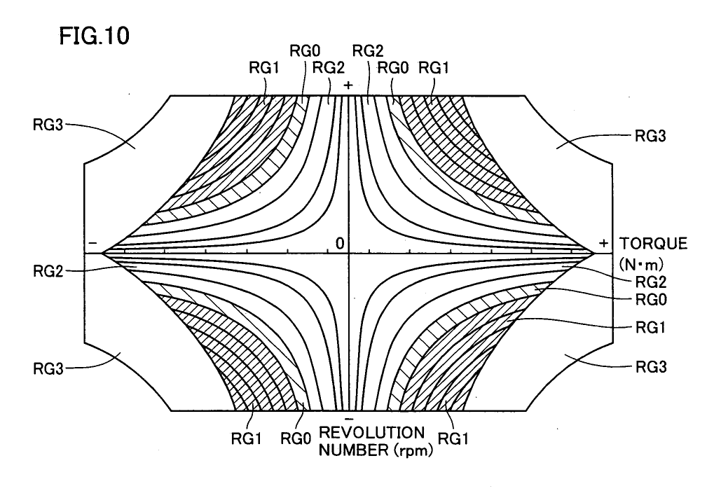

FIG. 10 is a diagram showing a map stored by temperature estimation unit 302 in FIG. 6. Temperature estimation unit 302 stores a map corresponding to each of AC motors M1, M2, although a map corresponding to AC motor M1 is representatively shown in FIG. 10. The map corresponding to AC motor M2 is similar to the map shown in FIG. 10.

Referring to FIG. 10, the axis of abscissas of the map shows the torque of the AC motor and the axis of ordinates of the map shows revolution number of the AC motor. A plurality of equal power lines are present in the coordinate plane represented by torque and revolution numbers. The coordinate plane includes regions RG0, RG1, RG2, RG3.

Region RG1 is a region in which heat generation of the magnet is large and demagnetization of the magnet occurs due to a continuous use of the motor. When the inverter is under PWM control and both the torque and the revolution number of the AC motor are high, the operating point defined by the torque and the revolution number of the AC motor is located in region RG1.

When the revolution number of the AC motor is high, control device 30 performs field weakening control. Field weakening control generally means that motor electromotive force that increases according to a motor revolution number is reduced by weakening a field thereby allowing a motor to be controlled up to a high speed region. In this case, the control is performed such that a demagnetizing field is applied to a permanent magnet in a d-axis direction (a direction parallel to the direction of the magnetic field produced by the permanent magnet). Therefore, in the high-speed side region, a demagnetization starting temperature tends to be decreased because of the field weakening control even when torque is reduced.

Regions RG2, RG3 are regions in which heat generation of the magnet is small and a magnet temperature is smaller than a demagnetization temperature because of a continuous use of the motor. When the inverter is under PWM control and both the torque and the revolution number of the AC motor are low, the operating point of the AC motor is located in region RG2. When the inverter is under rectangular wave control, the operating point of the AC motor is located in region RG3.

When the operating point is in a region RG0, a magnet temperature change is smaller than when the operating point is in regions RG1, 2.

Temperature estimation unit 302 sets a count value (° C./second) for each of regions RG0-RG3, based on this map. This count value is defined based on, for example, experimental results and designs. Temperature estimation unit 302 increments/decrements the count value based on a retention time of the operating point in the map. Temperature estimation unit 302 then estimates a magnet temperature based on the count value.

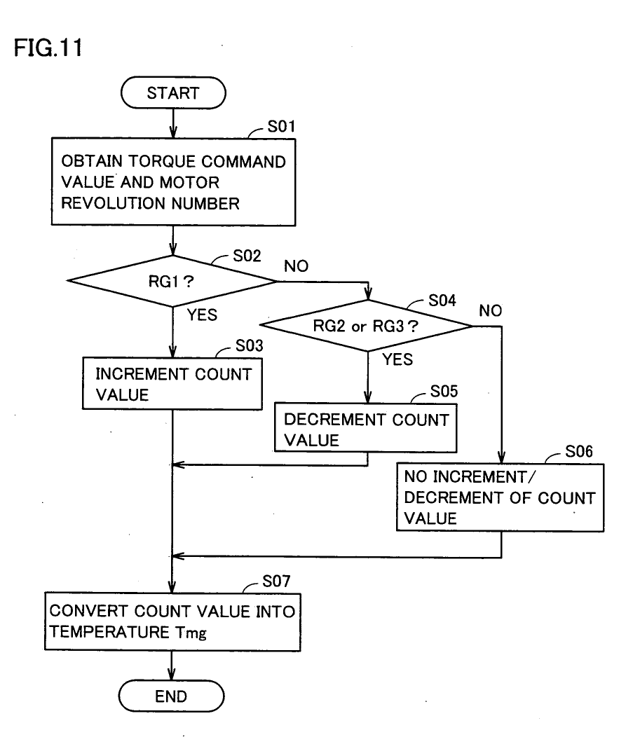

FIG. 11 is a flowchart illustrating a temperature estimation process executed by temperature estimation unit 302 in FIG. 6.

Referring to FIG. 11, temperature estimation unit 302 first obtains a torque command value and a motor revolution number (step S01). Temperature estimation unit 302 then refers to the map in FIG. 10 to specify in which region in the map the operating point of the AC motor as defined by the obtained torque command value and motor revolution number is located.

First, temperature estimation unit 302 determines whether or not the operating point is located in region RG1 (step S02). If the operating point is located in region RG1 (YES in step S02), temperature estimation unit 302 increments the count value (step S03). If the operating point is not located in region RG1 (NO in step S02), temperature estimation unit 302 determines whether or not the operating point is included in either one of region RG2 and region RG3 (step S04). If the operating point is included in region RG2 or RG3 (YES in step S04), temperature estimation unit 302 decrements the count value (step S05). If the operating point is not included in either region RG2 or RG3 (NO in step S04), temperature estimation unit 302 determines that the operating point is included in region RG0. In this case, temperature estimation unit 302 does not increment/decrement the count value (step S06).

When the process in any one of steps S03, S05, S06 ends, temperature estimation unit 302 converts the count value into magnet temperature Tmg (step S07). When the process in step S07 ends, the entire process ends.

[Control Method for AC Motor]

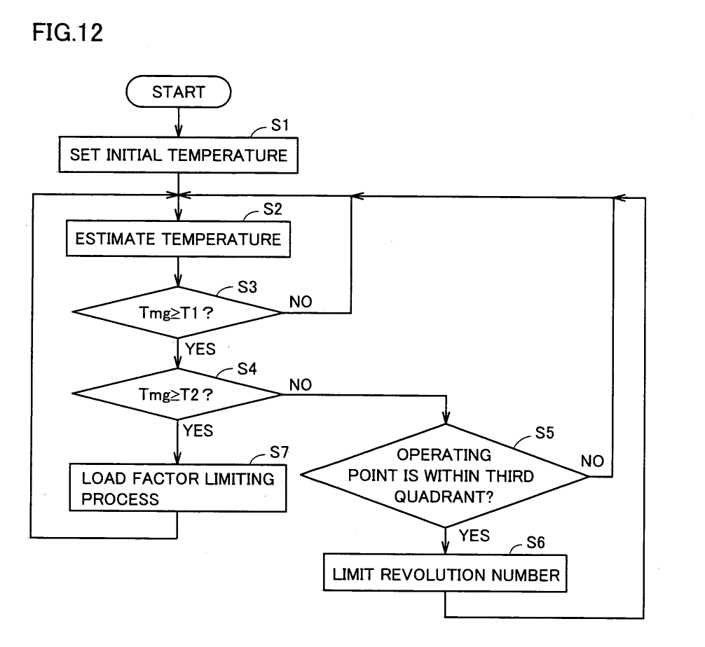

FIG. 12 is a flowchart illustrating a control process for AC motor M1 in the present embodiment. The process shown in FIG. 12 is invoked from the main routine for execution, for example, at a time of startup of hybrid vehicle drive apparatus 100.

Referring to FIG. 12 and FIG. 1, upon the start of the process, control device 30 sets an initial temperature of the permanent magnet included in the rotor of AC motor M1 (step S1). The process in step S1 is executed, for example, when a startup instruction is given to hybrid vehicle drive apparatus 100. Although not shown in FIG. 5 and the like, AC motors M1, M2 are each provided with a temperature sensor for sensing a temperature of the stator. Control device 30 sets the temperature of the stator sensed by the temperature sensor as the initial temperature of the permanent magnet. This is because it can be assumed that the magnet temperature is almost equal to the temperature of the stator immediately after the operation of AC motors M1, M2 is started.

Then, in step S2, control device 30 (more specifically temperature estimation unit 302 shown in FIG. 6) executes the process shown in the flowchart in FIG. 11 to estimate a temperature of the permanent magnet included in the rotor of AC motor M1.

In step S3, control device 30 determines whether or not magnet temperature Tmg is equal to or higher than a prescribed threshold temperature T1. If magnet temperature Tmg is equal to or higher than threshold temperature T1 (YES in step S3), the process proceeds to step S4. On the other hand, if magnet temperature Tmg is smaller than threshold temperature T1 (NO in step S3), the process returns to step S2.

In step S4, control device 30 determines whether or not magnet temperature Tmg is equal to or higher than a prescribed threshold temperature T2. Here, T2>T1. If magnet temperature Tmg is equal to or higher than threshold temperature T2 (YES in step S4), the process proceeds to step S7 as described later. On the other hand, if magnet temperature Tmg is smaller than threshold temperature T2 (NO in step S4), the process proceeds to step S5.

In step S5, control device 30 determines whether or not the operating point of AC motor M1 is within the third quadrant of an operating region of AC motor M1. The operating region is a coordinate plane defined by torque and revolution numbers of AC motor M1, similar to the map shown in FIG. 10. If the operating point is within the third quadrant of the operating region (YES in step S5), control device 30 limits the revolution number of AC motor M1 (step S6).

Specifically, control device 30 reduces the revolution number of AC motor M1 as the magnet temperature is higher. Accordingly, in the map shown in FIG. 10, the operating point of AC motor M1 moves from region RG1 to region RG2. As a result, the magnet temperature is decreased, thereby preventing demagnetization of the permanent magnet.

When magnet temperature Tmg becomes equal to or higher than threshold temperature T2, control device 30 executes a process of limiting torque of AC motor M1 (load factor limiting process) (step S7). Specifically, control device 30 limits current flowing in AC motor M1 (output current of inverter 14). When the process in step S7 ends, the process returns to step S2.

A revolution number limiting process and a load factor limiting process will now be described in detail.

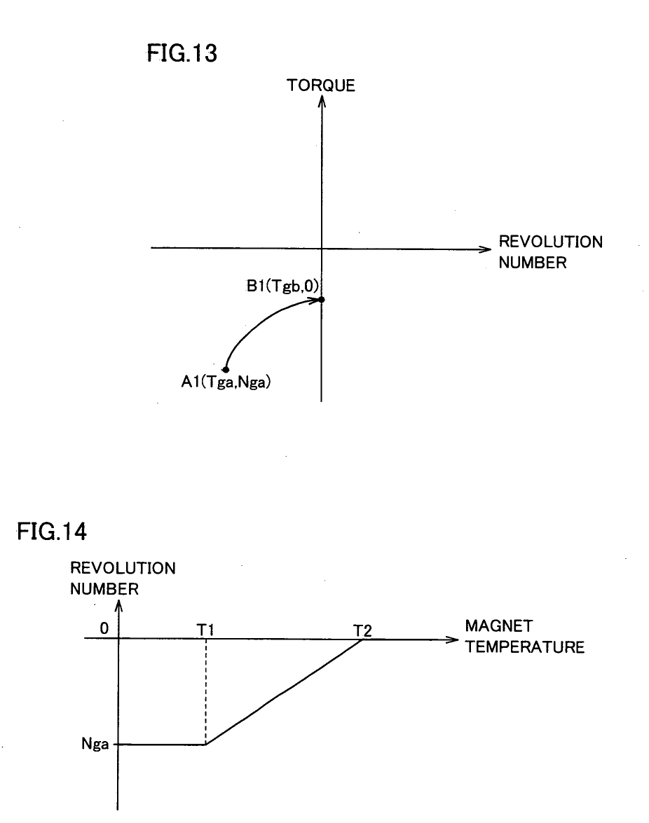

FIG. 13 is a graph illustrating a movement of the operating point of AC motor M1 in the revolution number limiting process.

FIG. 14 is a graph illustrating the relation between magnet temperature Tmg and the revolution number of AC motor M1.

Referring to FIG. 13 and FIG. 14, when magnet temperature Tmg is equal to or lower than T1, the revolution number is Nga (any given value) and the torque is Tga. When magnet temperature Tmg reaches threshold temperature T1, control device 30 reduces the revolution number of AC motor M1 according to magnet temperature Tmg. For example, as shown in FIG. 14, when magnet temperature Tmg rises from T1 to T2, the revolution number decreases from Nga to 0.

In this case, the operating point moves from a point A1 to a point B1 in the operating region shown in FIG. 13. When the operating point is B1, the torque of AC motor M1 is Tgb.

In hybrid vehicle 200 in the present embodiment, the operating point of AC motor M1 can be moved without changing engine power. This will be explained below.

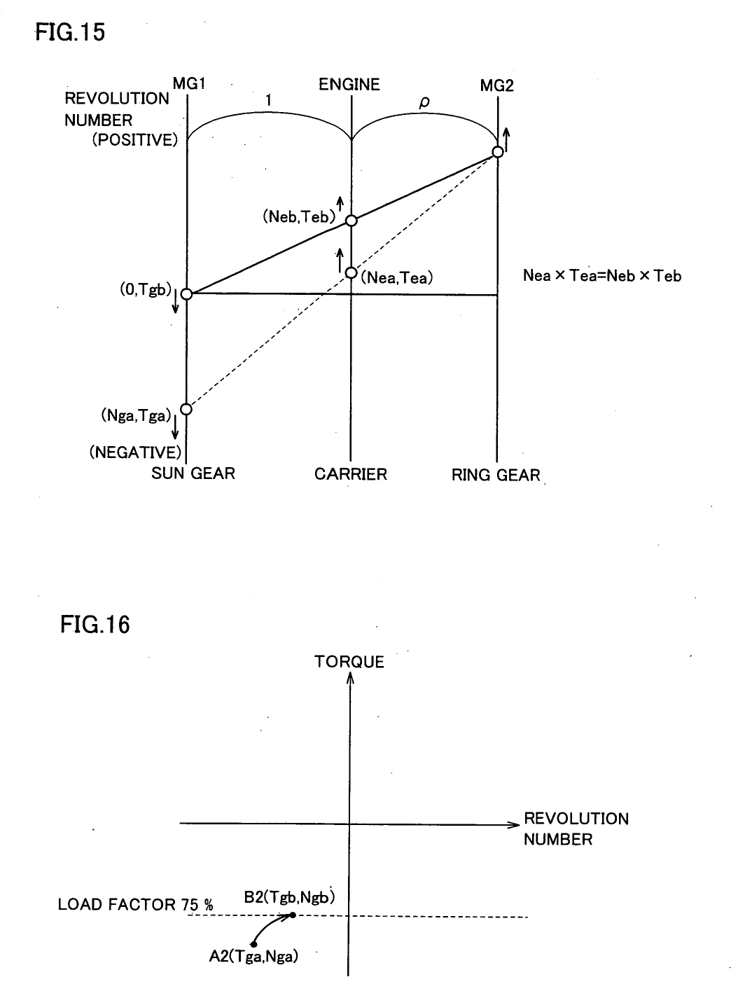

FIG. 15 is a nomographic chart for illustrating the operation of power split device 210 shown in FIG. 2.

Referring to FIG. 15 and FIG. 2, the revolution number of AC motor M1, the revolution number of AC motor M2 and the revolution number of engine 60 are located on a straight line when the revolution number of AC motor M1 and the revolution number of AC motor M2 are arranged at opposite sides of the engine revolution number. In other words, the revolution numbers of AC motors M1, M2 and the engine revolution number change in such a manner that they are always located on a straight line.

A single rotation of sun gear 213 yields p rotations of ring gear 211, which is an inverse gear ratio between sun gear 213 and ring gear 211. In the nomographic chart, when the distance between the axis of the carrier and the axis of the sun gear is 1, the distance between the axis of the carrier and the axis of the ring gear is ρ.

Referring to FIG. 15 and FIG. 13, when the operating point of AC motor M1 is point A1, the revolution number of the engine is Nea, and the torque of the engine is Tea. When the operating point of AC motor M1 moves from point A1 to point B1, the revolution number of the engine is changed from Nea to Neb, and the torque of the engine is changed from Tea to Teb. Here, the engine power (the engine revolution number×the engine torque) is constant. In other words, Nea×Tea=Neb×Teb.

Next, the load factor limiting process will be described.

FIG. 16 is a graph illustrating a movement of the operating point of AC motor M1 in the load factor limiting process.

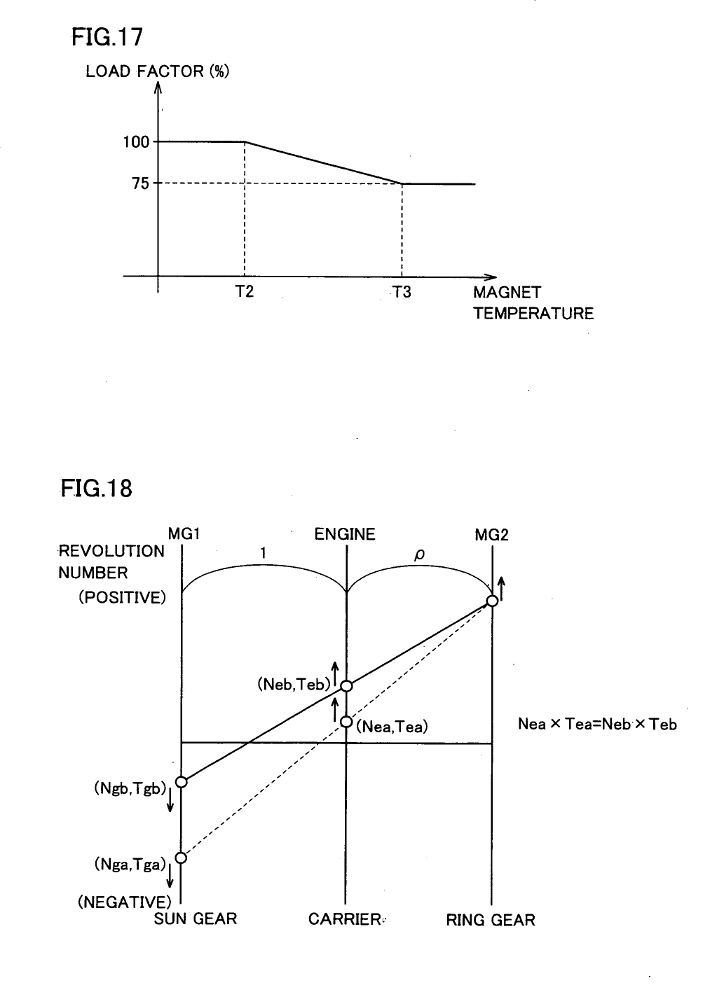

FIG. 17 is a graph illustrating the relation between magnet temperature Tmg and the load factor of AC motor M1.

Referring to FIG. 16 and FIG. 17, it is assumed that magnet temperature Tmg reaches T2 when the torque is Tga and the revolution number is Nga. Control device 30 then decreases the load factor according to magnet temperature Tmg. For example, when magnet temperature Tmg is T2, the load factor is 100%, and on the other hand, when magnet temperature Tmg is T3, the load factor is decreased to 75%.

In this case, the operating point moves from a point A2 to a point B2 in the third quadrant of the operating region. When the operating point is point B2, the torque and the revolution number of AC motor M1 are Tgb, Ngb, respectively. It is noted that the load factor limiting process is executed when the operating point is located in any of the first to fourth quadrants of the operating region.

FIG. 18 is a nomographic chart for illustrating the operation of power split device 210 in the load factor limiting process.

Referring to FIG. 18, also in the load factor limiting process, control device 30 changes the torque and the revolution number of AC motor M1 such that the engine power does not change. When the operating point of AC motor M1 is point A2, the revolution number of the engine is Nea and the torque of the engine is Tea. When control device 30 moves the operating point of AC motor M1 from point A2 to point B2, the revolution number of the engine is changed from Nea to Neb, and the torque of the engine is changed from Tea to Teb. Here, Nea×Tea=Neb×Teb.

In the third quadrant of the operating region, the operating point can be moved easily. For example, when the driver depresses the accelerator pedal harder, the vehicle can be accelerated. On the other hand, when the speed of the hybrid vehicle becomes extremely high, or when the hybrid vehicle travels on a hill, the operating point may sometimes be located in the fourth quadrant (the region next to the third quadrant on the right in the operating region shown in FIG. 13).

In this case, though depending on the engine, when it is intended to decrease the revolution number of AC motor M1, it may be difficult to decrease the revolution number of AC motor M1 because the engine revolution number has already reached the maximum revolution number. In addition, the engine revolution number may increase responsively to depression of the accelerator pedal.

As shown in the flowchart in FIG. 12, control device 30 limits the revolution number of AC motor M1 when the operating point of AC motor M1 is in the third quadrant of the operating region. Accordingly, it becomes possible to prevent louder engine noise and to prevent reduced fuel efficiency.

Furthermore, when magnet temperature Tmg reaches T2 higher than T1, control device 30 limits the load factor. When the load factor of AC motor M1 is limited, the acceleration performance of hybrid vehicle 200 is thought to be reduced. However, the revolution number is limited before the load factor is limited, so that it is possible to prevent demagnetization of the permanent magnet without depending on current limitation. In addition, by performing the revolution number limiting process for AC motor M1, any given revolution number of the rotor of AC motor M1 can be set while the effect on driving of hybrid vehicle 200 is reduced.

In the foregoing description, the determination process in step S5 is performed. However, there is a possibility that the determination in step S5 is not necessary, depending on the engine. In such a case, the process in step 6 is performed, for example, when such a condition that magnet temperature Tmg is equal to or higher than T1 and lower than T2 (YES in step S3 and NO in step S4) is satisfied.

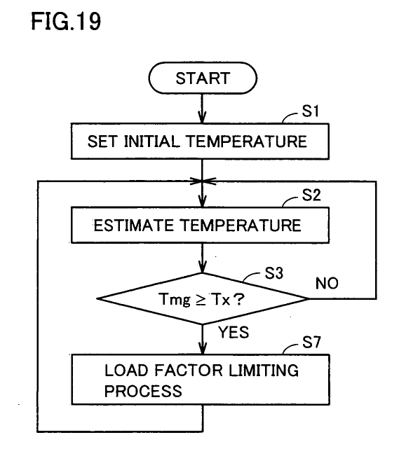

FIG. 19 is a flowchart illustrating a control process for AC motor M2 in the present embodiment. The process shown in the flowchart in FIG. 19 is invoked from the main routine for execution, for example, at a time of startup of hybrid vehicle drive apparatus 100, similarly to the flowchart shown in FIG. 12.

Referring to FIG. 19 and FIG. 12, the process in the flowchart in FIG. 19 differs from the process in the flowchart in FIG. 12 in that the processes in steps S5, S6 are not executed. In other words, the control process for AC motor M2 differs from the control process for AC motor M1 in that the revolution number control process is not executed.

In step S3, control device 30 determines whether or not magnet temperature Tmg of the permanent magnet included in the rotor of AC motor M2 is equal to or higher than a prescribed temperature Tx. If magnet temperature Tmg is equal to or higher than temperature Tx (YES in step S3), control device 30 limits the load factor of AC motor M2 (step S7). Temperature Tx may be defined appropriately according to the characteristics of AC motor M2. For example, temperature Tx may be set almost equal to temperature T2 or may be set higher than temperature T2.

AC motor M2 drives front wheels 230 through power split device 210. Therefore, if the revolution number limitation is also performed on AC motor M2, similarly to AC motor M1, driving of hybrid vehicle 200 may be affected. However, when magnet temperature Tmg exceeds temperature Tx, control device 30 reduces the magnet temperature by performing the load factor limiting process. Accordingly, it becomes possible to prevent demagnetization of the permanent magnet included in the rotor of AC motor M2 while the effect on driving of hybrid vehicle 200 is minimized.

[Other Control Methods]

As shown in FIG. 9, when the carrier frequency is increased, the harmonic component of current flowing in the stator becomes smaller. Accordingly, the magnetic field variation in the permanent magnet of the rotor also becomes small, so that eddy current produced in the permanent magnet is reduced. Such a method can also prevent demagnetization of the permanent magnet.

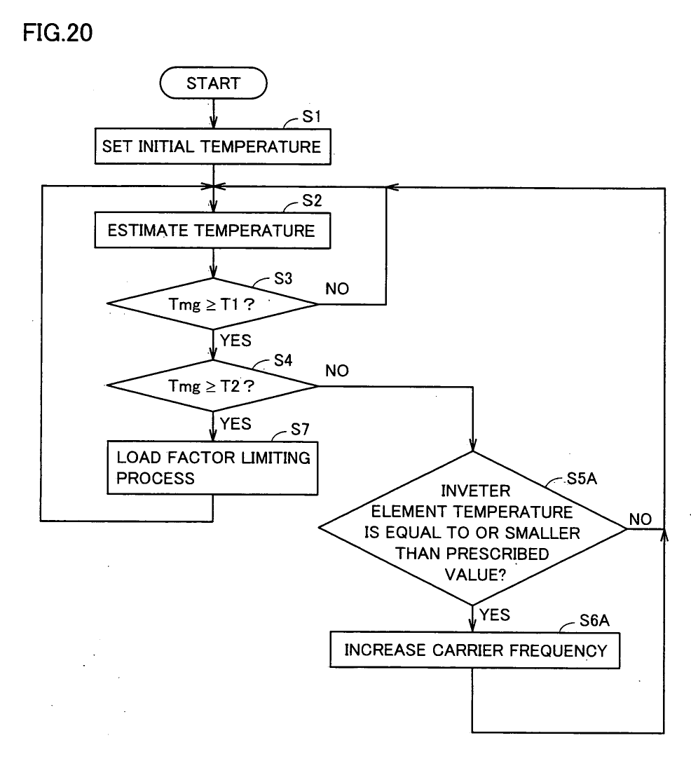

FIG. 20 is a flowchart showing another example of the control process for AC motors M1, M2. It is noted that the process shown in the flowchart in FIG. 20 is executed for each of AC motors M1, M2.

Referring to FIG. 20 and FIG. 12, the process in the flowchart in FIG. 20 differs from the process in the flowchart in FIG. 12 in that processes in steps S5A, S6A are executed in place of the processes in steps S5, S6. The processes in other steps of the process in the flowchart in FIG. 20 are similar to the processes in the corresponding steps in the flowchart in FIG. 12, and therefore the remaining description will not be repeated.

In step S5A, control device 30 determines whether or not an element temperature (a temperature of IGBT element) of inverter 14 is equal to or smaller than a prescribed value. If magnet temperature Tmg is equal to or smaller than a prescribed value (YES in step S5A), control device 30 increases the carrier frequency of triangular wave signal k2 shown in FIG. 8 (step S6A). Thus, the carrier frequency (switching frequency) of inverter 14 is increased.

When the carrier frequency is increased, however, the element temperature may be increased because of an increase of switching loss in inverter 14. When the element temperature becomes too high, the inverter element may be damaged. Therefore, control device 30 increases the carrier frequency only when the element temperature of inverter 14 is determined to be equal to or smaller than a prescribed value in step S5A. Accordingly, damage to the inverter element can be prevented.

Here, the threshold temperature (temperature T1) in step S2 and a prescribed value in step S5A may be equal or may be different between AC motors M1 and M2. If magnet temperature Tmg is larger than a prescribed value in step S5A (NO in step S5A), or when the process in step S6A ends, the process returns to step S2.

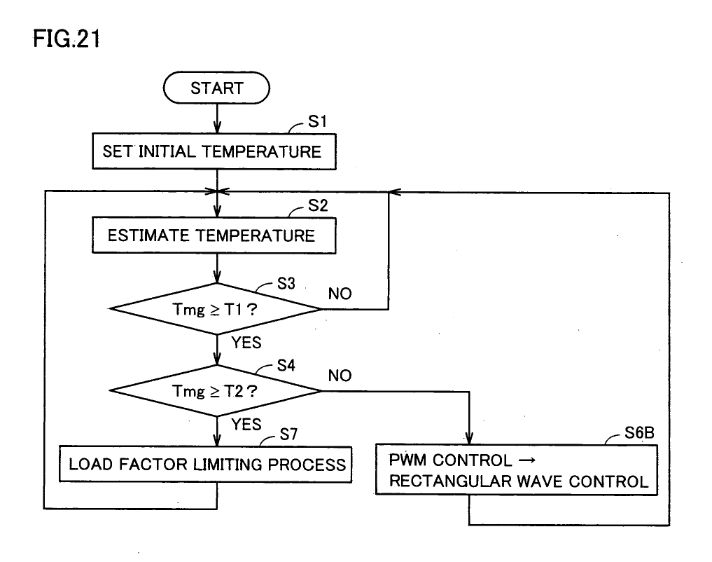

FIG. 21 is a flowchart showing yet another example of the control process for AC motors M1, M2. The process shown in the flowchart in FIG. 21 is executed for each of AC motors M1, M2. The processes in other steps in the process in the flowchart in FIG. 21 are similar to the processes in the corresponding steps in the flowchart in FIG. 12, and therefore the remaining description will not be repeated.

Referring to FIG. 21 and FIG. 12, the process in the flowchart in FIG. 21 differs from the process in the flowchart in FIG. 12 in that the process in step S5 is not executed and in that the process in step S6B is executed in place of the process in step S6.

If magnet temperature Tmg is smaller than T2 in step S4 (NO in step S4), control device 30 changes the control mode of AC motor M1 (M2) from a PWM control mode to a rectangular wave control mode (step S6B). When the process in step S6B ends, the entire process returns to step S2. Similarly to the flowchart in FIG. 21, the threshold temperature (temperature T1) in step S2 may be equal or may be different between AC motors M1 and M2.

Generally, the harmonic component of current flowing in the coil of the stator can be made smaller by driving the AC motor in the rectangular control mode than by driving the AC motor in the PWM control mode. Therefore, similarly to the case where the carrier frequency is increased in the PWM control mode, the eddy current produced in the permanent magnet is reduced, so that demagnetization of the permanent magnet can be prevented.

As described above, in accordance with the present embodiment, a drive control apparatus for AC motor is mounted on hybrid vehicle 200. The drive control apparatus includes inverter 14 driving AC motor M1 and control device 30 controlling inverter 14 by switching the control mode of inverter 14 between the first mode (PWM control mode) and the second mode in which the harmonic component of output current of inverter 14 can be suppressed as compared with in the first mode. Control device 30 controls inverter 14 in the first mode when the magnet temperature of the permanent magnet is smaller than a first threshold temperature, and controls inverter 14 in the second mode when the magnet temperature is equal to or higher than the first threshold temperature.

In the present embodiment, “second mode” refers to a mode in which inverter 14 is under PWM control and the revolution number of AC motor M1 is reduced (see step S6 in FIG. 12), a mode in which inverter 14 is under PWM control and the carrier frequency of inverter 14 is reduced (see step S6A in FIG. 20), and a rectangular wave control mode (see step S6B in FIG. 21). Thus, an increase of the magnet temperature can be suppressed. Therefore, in accordance with the present embodiment, it becomes possible to prevent demagnetization of the permanent magnet.

It is noted that converter control unit 301, temperature estimation unit 302, and inverter control unit 303 in control device 30 in the present embodiment each may be formed of circuitry having a function corresponding to each block or may be realized by the control unit executing processes in accordance with a preset program. In the latter case, the control of control device 30 as described above is performed by a CPU (Central Processing Unit), and CPU reads from a ROM (Read Only Memory) a program for executing the above-noted functional blocks and the processes shown in the flowcharts and executes the read program to execute the processes in accordance with the above-noted functional blocks and the flowcharts. Therefore, ROM is equivalent to a computer (CPU) readable recording medium having a program recorded thereon for executing the above-noted functional blocks and the processes shown in the flowcharts.

It should be understood that the embodiment disclosed herein should be illustrative rather than limitative in all respects. The scope of the present invention is not shown in the foregoing description but in the claims, and the equivalents to the claims and all the modifications within the claims are intended to be embraced.

1. A drive control apparatus for a first rotating electric machine including a first rotor including a first permanent magnet, comprising:
a temperature estimation unit for estimating a temperature of said first permanent magnet based on a first operating condition requested of said first rotating electric machine, and for outputting a magnet temperature as the estimation result;
a first inverter for driving said first rotating electric machine to rotate said first rotor; and
a control unit having, as control modes of said first inverter, a first mode and a second mode in which a harmonic component of output current from said first inverter to said first rotating electric machine can be suppressed as compared with in said first mode, for controlling said first inverter in said first mode when said magnet temperature is smaller than a first threshold temperature, and for controlling said first inverter in said second mode when said magnet temperature is larger than said first threshold temperature, wherein
said control unit limits the output current of said first inverter in a case where said magnet temperature exceeds a second threshold temperature, when said first inverter is controlled in said second mode.

2. (canceled)

3. The drive control apparatus for the rotating electric machine according to claim 1, wherein
said first mode is a pulse width modulation control mode, and
said second mode is a rectangular wave control mode.

4. The drive control apparatus for the rotating electric machine according to claim 1, wherein when said control mode is said second mode, said control unit controls said first inverter such that a revolution number of said first rotating electric machine is reduced as compared with when said control mode is said first mode.

5. The drive control apparatus for the rotating electric machine according to claim 4, wherein
said first rotating electric machine is mounted on a vehicle,
said vehicle including
a drive wheel,
a second rotating electric machine for rotating said drive wheel,
an internal combustion engine, and
a power split device configured to have said second rotating electric machine and said drive wheel coupled thereto and have said internal combustion engine and said first rotating electric machine coupled thereto so that a revolution number of said second rotating electric machine is uniquely defined from a revolution number of said first rotating electric machine and a revolution number of said internal combustion engine, and wherein
when the revolution number of said first rotating electric machine is decreased, said internal combustion engine increases the revolution number of said internal combustion engine so that the revolution number of said second rotating electric machine is kept constant.

6. The drive control apparatus for the rotating electric machine according to claim 5, wherein
said second rotating electric machine includes a second rotor including a second permanent magnet,
said temperature estimation unit estimates a temperature of said second permanent magnet based on a second operating condition requested of said second rotating electric machine,
said drive control apparatus further comprises a second inverter for driving said second rotating electric machine to rotate said second rotor, and
when the temperature of said second permanent magnet as estimated by said temperature estimation unit exceeds a prescribed temperature, said control unit limits output current from said second inverter to said second rotating electric machine.

7. The drive control apparatus for the rotating electric machine according to claim 1, wherein when said control mode is said second mode, said control unit increases a carrier frequency of said first inverter as compared with when said control mode is said first mode.

8. A vehicle comprising:
a first rotating electric machine including a first rotor having a first permanent magnet; and
a drive control apparatus for driving and controlling said first rotating electric machine,
said drive control apparatus including
a temperature estimation unit for estimating a temperature of said first permanent magnet based on a first operating condition requested of said first rotating electric machine, and for outputting a magnet temperature as the estimation result,
a first inverter for driving said first rotating electric machine to rotate said first rotor, and
a control unit having, as control modes of said first inverter, a first mode and a second mode in which a harmonic component of output current from said first inverter to said first rotating electric machine can be suppressed as compared with in said first mode, for controlling said first inverter in said first mode when said magnet temperature is smaller than a first threshold temperature, and for controlling said first inverter in said second mode when said magnet temperature is larger than said first threshold temperature, wherein
said control unit limits the output current of said first inverter in a case where said magnet temperature exceeds a second threshold temperature, when said first inverter is controlled in said second mode.

9. (canceled)

10. The vehicle according to claim 8, wherein
said first mode is a pulse width modulation control mode, and
said second mode is a rectangular wave control mode.

11. The vehicle according to claim 8, wherein when said control mode is said second mode, said control unit controls said first inverter such that a revolution number of said first rotating electric machine is reduced as compared with when said control mode is said first mode.

12. The vehicle according to claim 11, further comprising:
a drive wheel;
a second rotating electric machine for rotating said drive wheel;
an internal combustion engine; and
a power split device configured to have said second rotating electric machine and said drive wheel coupled thereto and have said internal combustion engine and said first rotating electric machine coupled thereto so that a revolution number of said second rotating electric machine is uniquely defined from a revolution number of said first rotating electric machine and a revolution number of said internal combustion engine, wherein
when the revolution number of said first rotating electric machine is decreased, said internal combustion engine increases the revolution number of said internal combustion engine so that the revolution number of said second rotating electric machine is kept constant.

13. The vehicle according to claim 12, wherein
said second rotating electric machine includes a second rotor having a second permanent magnet,
said temperature estimation unit estimates a temperature of said second permanent magnet based on a second operating condition requested of said second rotating electric machine,
said drive control apparatus further includes a second inverter for driving said second rotating electric machine to rotate said second rotor, and
when the temperature of said second permanent magnet as estimated by said temperature estimation unit exceeds a prescribed temperature, said control unit limits output current from said second inverter to said second rotating electric machine.

14. The vehicle according to claim 8, wherein when said control mode is said second mode, said control unit increases a carrier frequency of said first inverter as compared with when said control mode is said first mode.
